(19) United States
(12) Patent Application Publication
(10) Pub. No.: US 2016/0146450 A1
(43) Pub. Date: May 26, 2016

(54) FLEXIBLE WATER-RESISTANT OPTICAL FIBER LIGHT DISPLAY

(71) Applicant: Radiant Enterprises, LLC, Los Angeles, CA (US)

(72) Inventor: Igal Franck Benhamou, Beverly Hills, CA (US)

(21) Appl. No.: 14/950,733

(22) Filed: Nov. 24, 2015

Related U.S. Application Data
(60) Provisional application No. 62/123,711, filed on Nov. 26, 2014.

(51) Int. Cl. F21V 33/00; F21V 8/00; F21V 31/00; F21V 23/04; F21S 9/02

(52) U.S. Cl. CPC F21V 33/0008; F21V 23/0471; F21V 23/0485; F21S 9/02; F21V 31/005; G02B 6/0008; G02B 6/0006; F21Y 2101/02; F21W 2121/06

(57) ABSTRACT

A light display assembly is configured to be affixed to a textile. The light display assembly comprises a light-generating segment, a light-emitting segment, and a water-tight enclosure. The light-generating segment is configured to be disposed adjacent to a rough side of the textile. The light-emitting segment is configured to receive light from the light-generating segment and emit the light so as to be viewable from a finished side of the textile. The water-tight enclosure encases the light-generating segment and at least a portion of the light-emitting segment so as to allow the light display assembly to be washed in conjunction with the textile.

### RELATED APPLICATIONS

This non-provisional patent application claims priority benefit, with regard to all common subject matter, of earlier-filed U.S. Provisional Patent Application No. 62/123,711, filed on Nov. 26, 2014, and entitled “FLEXIBLE WATER-RESISTANT OPTICAL FIBER LIGHT DISPLAY.” The identified earlier-filed provisional patent application is hereby incorporated by reference in its entirety into the present application.

### BACKGROUND

1. FIELD

Embodiments of the invention relate to light displays for adherence to textiles or other objects. More specifically, embodiments of the invention relate to a light display assembly secured to the textile article via a water-tight enclosure.

2. RELATED ART

Lighted displays are common to project light through textiles (or similar substances) for various aesthetic and safety reasons. However, light displays provide numerous drawbacks that reduce their general usage. First, typically these light displays include external power sources, such as powered by large batteries. These batteries require periodic replacement and are too bulky for many applications. Second, these light displays are typically activated by a physical switch. This requires the user to physically turn the light display on and off, which reduces usefulness and leads to battery drain. Third, these light displays are bulky so as to prohibit or reduce their use in clothing items. The bulky components are typically visible through the textile article, so as to reduce aesthetic appeal. Fourth, these light displays are not water-resistant, which prevents washing of the textile article.

### SUMMARY

Embodiments of the invention solve the above-mentioned problems by providing a light display assembly configured to be associated with a textile article. The light display assembly draws a minimal amount of power and includes a power source that is long lasting so as to preclude the need for replacing the batteries. The light display assembly is activated by a switch designed to activate the display sealed inside the apparel like a motion sensor, magnetic field sensor, photo sensor or other switch type so as to improve water resistance and to automatically activate as a wearer (or other user) moves. The light display assembly is small, lightweight, and ergonomic so as to be virtually unnoticeable to an observer (save for the light emitted and a design decal). Finally, the light display assembly is encased in a water-tight enclosure, such as a silicone coating over the components, so as to allow for repeated washings.

A first embodiment of the invention is generally directed to a light display assembly configured to be affixed to a textile. The light display assembly comprises a light-generating segment, a light-emitting segment, and a water-tight enclosure. The light-generating segment is configured to be disposed adjacent to a rough side of the textile. The light-emitting segment is configured to receive light from the light-generating segment and emit the light so as to be viewable from a finished side of the textile. The water-tight enclosure encases the light-generating segment and at least a portion of the light-emitting segment so as to allow the light display assembly to be washed in conjunction with the textile.

A second embodiment of the invention is generally directed to a lighted textile system. The lighted textile system comprises a textile article, a light-generating segment, a light-emitting segment, and a water-tight enclosure. The textile article presents a finished side that is viewable by an observer and a rough side that is obscured from the observer. The light-generating segment is secured to the rough side of the textile article. The light-emitting segment is configured to receive light from the light-generating segment and emit the light so as to be viewable from the finished side of the textile article. The water-tight enclosure encases the light-generating segment and at least a portion of the light-emitting segment such that the lighted textile system can be washed.

A third embodiment of the invention is generally directed to a method of displaying a light pattern on a textile article, the method comprising the following steps: programming a circuit board with a set of instructions indicative of the desired light pattern; securing the circuit board, a light source, and a battery to a rough side of the textile article; securing a distal end of a plurality of optical fibers to the light source such that a proximal end of said plurality of optical fibers directs the light outward away from the surface of a finished side of the textile article; and encasing the circuit board, the light source, and the battery in a water-tight enclosure so as to allow the textile article to be safely washed without removing the circuit board, the light source, and the battery.

Additional embodiments of the invention are directed to a method of installing a light display assembly onto a textile, a method of programming a circuit board with a certain pattern, a method of lining the textile with a flexible backing for the light display assembly to conform to a wearer's body, and a method of diffusing light output through an additional material added to the surface above the light emitting tips of optical fibers.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWINGS

Embodiments of the invention are described in detail below with reference to the attached drawing figures, wherein:

FIG. 1A is a rough side view of a first embodiment of a lighted textile system, more specifically a lighted display assembly on a back pocket for a pair of jeans;

FIG. 1B is a rough side view of a second embodiment of a lighted textile system that includes a pressure activation switch;

FIG. 2 is a finished side view of the lighted textile system of FIG. 1A or FIG. 1B, illustrating the design decal visible from the finished side which displays the light;

FIG. 3 is a finished side view of a lighted textile system, more specifically a lighted display assembly on a pair of jeans;

FIG. 4 is a top view of a lighted display assembly;

FIG. 5 is a circuit diagram illustrating an exemplary integrated circuit that could be utilized to display a certain lighting sequence with the light display assembly;

FIG. 6 is a side view of the light display assembly being installed on the textile article, namely the mold cover being applied over the components of a light-generating segment;

FIG. 7 is a side view of the light display assembly of FIG. 6 with the mold cover in place;

FIG. 8 is a schematic diagram showing the light display assembly including how optical fibers produce light from the design decal; and

FIG. 9 is a side view of a design decal showing how the optical fibers traverse a design decal and are held in place by a mushroom end.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention may be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etcetera described in one embodiment may also be included in other embodiments, but is not necessarily included. Thus, the invention can include a variety of combinations and/or integrations of the embodiments described herein.

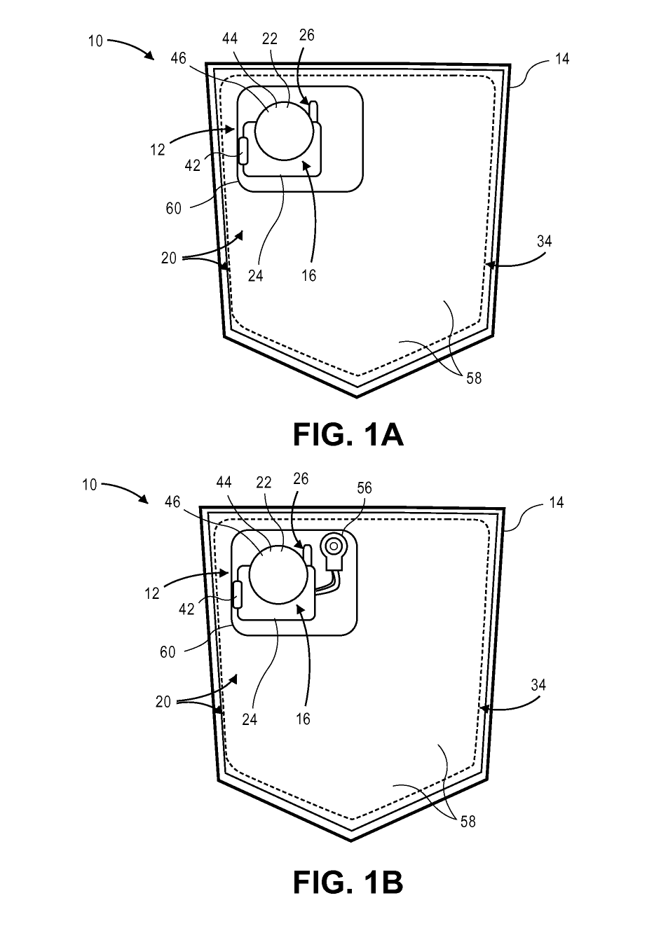

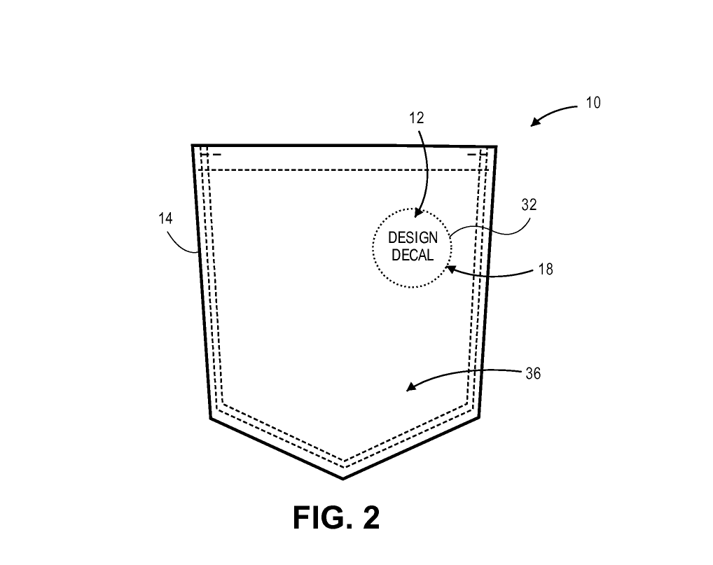

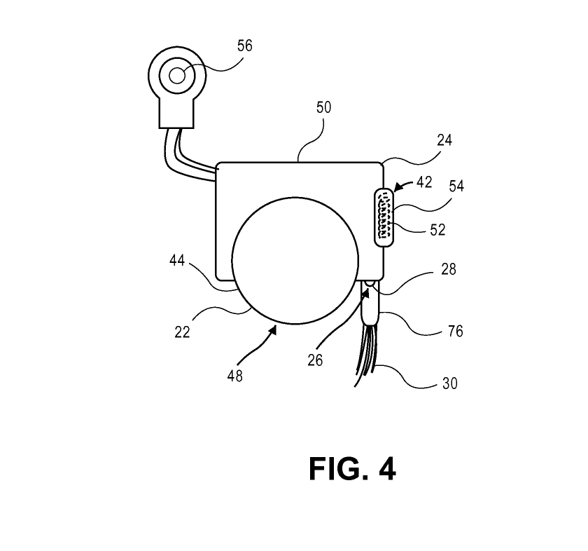

Turning to the figures, and especially FIG. 1A, embodiments of the invention are directed to a lighted textile system 10 that comprises a light display assembly 12 affixed to a textile article 14. The light display assembly 12 generally comprises a light-generating segment 16, a light-emitting segment 18 as shown in FIG. 2, and a water-tight enclosure 20. The light-generating segment 16 includes a battery 22, a circuit board 24, and a light source 26 (such as a light-emitting diode 28). The light-emitting segment 18 includes a plurality of optical fibers 30 as shown in FIG. 4 and a design decal 32 for displaying the light. The light display assembly 12 is disposed at least in part on a rough side 34 of the textile article 14 and creates a light that is visible from a finished side 36 of the textile article 14. The light may either be emitted directly or through the textile article 14. The light can serve any of several purposes, such as aesthetics, safety, communication, and the like.

It should be appreciated that while the majority of this description is concerned with the field of apparel, this is only an exemplary use for the invention. Other exemplary fields of use for the invention could include a wide variety of articles and items. Embodiments of the invention could be utilized for safety equipment such as safety vests, safety helmets, and the like to provide an easily visible indication of a location of the user. For example, police officer, traffic directors, and construction workers perform tasks that can be dangerous in low-light conditions. Similarly, life preservers, life rafts, mountaineering equipment, hiking equipment, and the like are used in emergency situations in which it would be desirable to have a reliable lighting source to help rescuers and others to locate the user. Current safety equipment will typically only shine by reflecting a light being shined upon it. The invention could be utilized to emit light without a light being shined upon it.

Embodiments of the invention could be utilized to illuminate paper products, posters, and the like. For example, movie posters and advertisements could be enhanced by providing certain lighting sequences to accentuate them. Embodiments of the invention would therefore be small and self-contained such that the components would not be readily apparent to an observer and minimal maintenance would be required.

Embodiments of the invention could be utilized to identify individuals in low-light situations. For example, military and para-military personnel could utilize an embodiment of the invention to provide friendly identification and authentication, such as by emitting a certain sequence in an ultra-violet range that is observable through night-vision devices. The certain sequence could be indicative of a personal or unit identity, relay information such as distress, information indicative of a radio frequency for communication, or the like.

Further, the majority of this description refers to a textile. In embodiments, a textile is a flexible woven material comprising a network of natural or artificial fibers. Textiles move naturally with the wearer for comfort. Embodiments of the invention adhere directly to the textile. For this reason, it is desirable that the light display assembly 12 flex so as to remain in contact with the textile. The textile may allow the optical fibers 30 to pass between natural or artificial fibers that make up the textile.

It should be appreciated that, as used herein, “textile” refers to any flexible membrane whether or not it is formed of a fibers. The term “textile” is utilized for clarity and simplicity but not to limit the invention. Embodiments of the invention could be utilized to adhere to and appear through any of numerous types of materials, such as plastic (e.g., on a safety helmet, a bicycle helmet, or a toy), paper (e.g., on a poster or advertisement), KEVLAR (e.g., on a KEVLAR helmet or vest), leather (e.g., on a ball glove or jacket), etc.

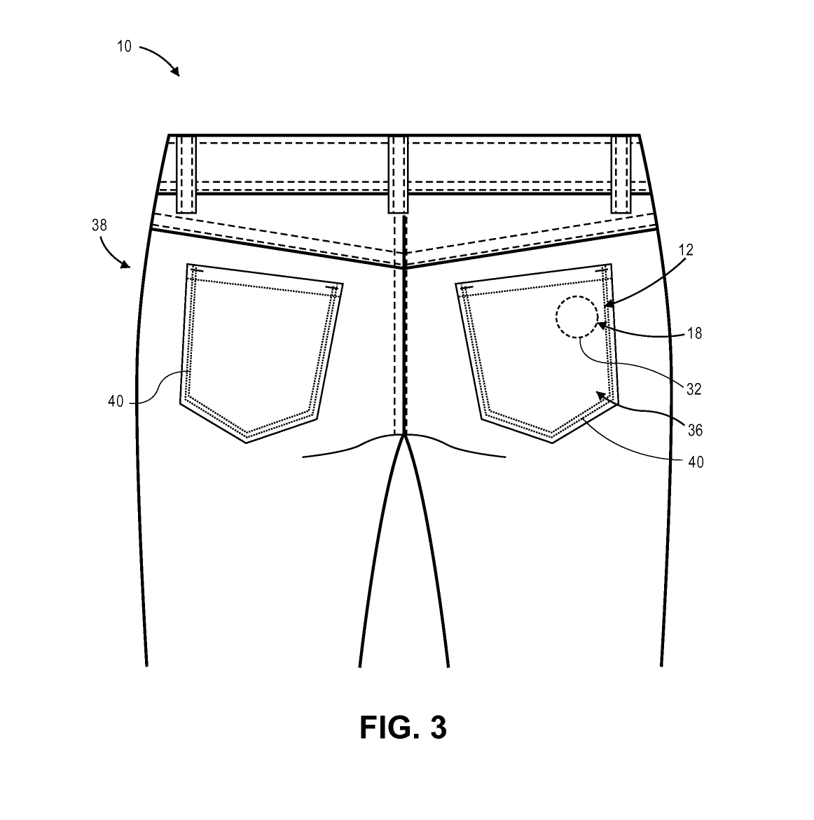

Returning to the exemplary field of apparel, the textile article 14 is a completed or substantially completed item formed of the textile. For example, the textile article 14 could be a pair of jeans 38 as illustrated in FIG. 3. The textile article 14 could also be any of numerous other types of apparel such as shirts, jackets, shorts, hats, backpacks, shoes, etc. The textile article 14 could also be a component of the total textile article 14 that will later be added to the textile article 14. For example, in FIG. 2 the textile article 14 illustrated is a back pocket 40 for the pair of blue jeans 38 in FIG. 3. The back pocket 40 is considered a textile article 14 even though it is not a finished, wearable item.

The textile article 14 is formed of at least one textile sheet. Textiles and similar materials typically include a finished side 36 and a rough side 34. The finished side 36 (also known as the “right side,” the “outer side,” or the “face”) is configured to be displayed outward toward an observer. The rough side 34 (also known as the “wrong side,” the “inner side,” or the “back”) is configured to be hidden from the view of an observer. The rough side 34 may be against the skin of the wearer, inside a pocket 40, between two layers of textile, showing stitching, etc. It should be noted that the finished side 36 and the rough side 34 are used to clarify a certain side of the textile, not to describe a certain quality of the textile. In embodiments of the invention, the finished side 36 and the rough side 34 of the textile are indistinguishable from one another. The finished side 36 and the rough side 34 are therefore defined by their placement (or eventual placement) within the textile article 14.

Embodiments of the invention are directed to a lighted textile system 10. The lighted textile system 10 includes the textile article 14, the light-generating segment 16, the light-emitting segment 18, and the water-tight enclosure 20. As discussed above, the textile article 14 presents the finished side 36 that is viewable by an observer and the rough side 34 that is obscured from the observer. The light-generating segment 16 is secured to the rough side 34 of the textile article 14, such that it is not readily visible by an observer. The light-emitting segment 18 is configured to receive light from the light-generating segment 16 and emit the light so as to be viewable from the finished side 36 of the textile article 14. In some embodiments, a portion of the light-emitting segment 18 traverses the textile so as to emit the light directly toward the observer. In other embodiments, the water-tight enclosure 20 that encases the light-generating segment 16 and at least a portion of the light-emitting segment 18 such that the lighted textile system 10 can be washed.

In embodiments of the invention, the lighted textile system 10 is manufactured and sold as a completed textile article 14 with the light display assembly 12 thereon. In this way, the consumer need not perform any installation or maintenance steps. The lighted textile system 10 arrives at either a retail location or directly to the consumer ready to wear and use. The light-generating segment 16 of the light display assembly 12 is secured to the rough side 34 of the textile and to the light-emitting segment 18. The light-emitting segment 18 includes a plurality of optical fibers 30 and a design decal 32 (which may include an embroidery, decal, or other method to display graphic images) disposed on the finished side 36 of the textile article 14. In embodiments of the invention, at least a portion of each optical fiber 30 traverses the textile article 14 and the design decal 32 from the rough side 34 to the finished side 36 such that the light emitted from the optical fibers 30 is viewable directly from the finished side 36.

In other embodiments of the invention, the lighted textile system 10 is manufactured and sold as a component that can be added to an existing textile article 14 (either sold concurrently with or previously owned by the consumer). For example, the lighted textile system 10 could be a patch to be added to a clothing item or backpack (not illustrated). The patch would include a textile article 14 that is configured to be sewn or adhered to the clothing item or backpack. The patch could thereafter be removed and replaced upon the battery 22 becoming depleted, the light display assembly 12 becoming damaged, etc. As another example, the lighted textile system 10 could be a pocket 40 or other add-on feature to be added to the textile article 14. The jean pocket 40 as illustrated in FIGS. 1A, 1B, and 2 could be sold to be secured to a pair of jeans 38 already owned by the consumer. The consumer would then sew or secure the pocket 40 via an adhesive.

In still other embodiments, the light display assembly 12 is manufactured and sold as a component that can be added to an existing textile article 14 (ether sold concurrently with or previously owned by the consumer). The consumer may cut through the textile article 14 and secure the light-generating segment 16 to the rough side 34 of the textile. The consumer also secures a portion of the light-emitting side to the finished side 36, traverses the textile, and secures it to the light-generating segment 16. These embodiments would require a fairly complex installation, but would allow the consumer to fully customize any textile article 14 they own.

Turning to FIG. 4, the various components of the light display assembly 12 will now be discussed in greater detail. The light-generating segment 16 is configured to be disposed adjacent to a rough side 34 of the textile and includes the battery 22, the circuit board 24, and the light source 26. The battery 22 provides power to the circuit board 24 and the light source 26. The circuit board 24 instructs the light source 26 to produce light in accordance with a certain sequence, as discussed below. In embodiments of the invention, the light-generating segment 16 includes a motion activation switch 42 or other type of activation switch to instruct the circuit board 24 to begin or end a lighting sequence.

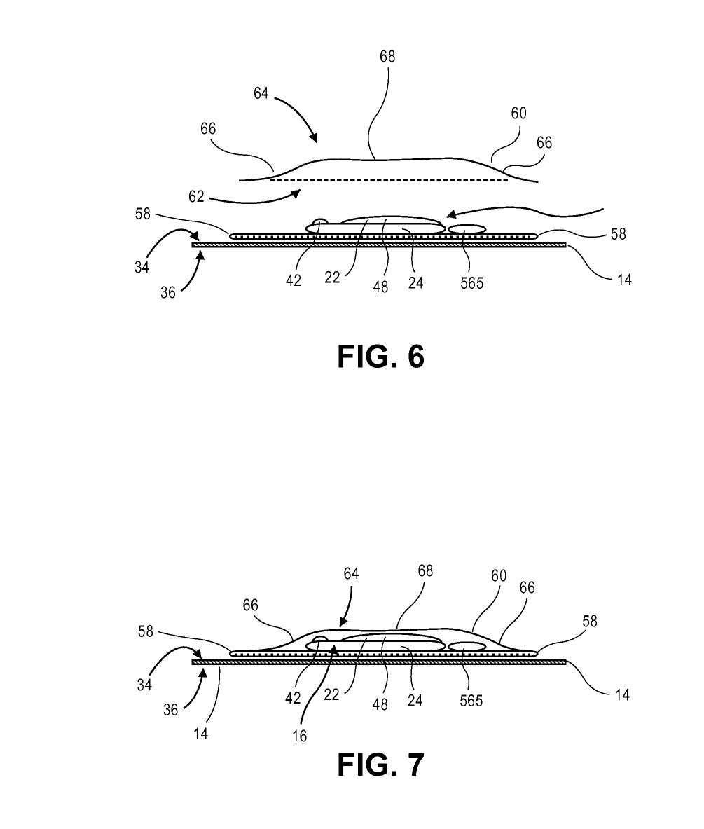

In embodiments of the invention, the battery 22 is a button cell 44 (also known as a coin-style battery). The battery 22 includes two circular endcaps 46 (as best illustrated in FIG. 4) and a circular sidewall 48 (as best illustrated in FIG. 6). There are numerous different types, sizes, and charges of button cells 44 that would be useful in the invention. Two example variations that could be utilized include the 2032 Lithium Battery, which is relatively thin, and the 2450 Lithium Battery, which is thicker but provides more power.

Numerous considerations are considered when selecting a type and size of battery 22 to use with the display assembly. One consideration is the typical power draw of the other components that are powered by the battery 22 both per iteration of the light sequence and in a standby mode. A second consideration is the number of desired light sequence iterations (e.g., at least 10,000, at least 25,000, at least 50,000, at least 100,000, etc.) during the battery 22 life. It should be appreciated that in certain embodiments of the invention the battery 22 is not replaceable without destroying the water-tight enclosure 20 (discussed below). As such the number of iterations is important because the drainage of charge from the battery 22 will render the display assembly no longer useful. A third consideration is the comfort of the user. Depending on where or if the light display assembly 12 will be relative to the user, the thickness and overall size of the battery 22 may be important. For example, if the light display assembly 12 is configured to be worn against the skin (e.g., on a t-shirt), a very small battery 22 may be desirable. If the light display assembly 12 is configured to be worn on the body but not against the skin (e.g., on the pocket 40 of a pair of jeans 38, as illustrated in FIG. 2, or a safety vest) a small battery 22 may be desirable because the battery 22 may press against the body in certain situations. If the light display assembly 12 is configured to be away from the users body (e.g., in a backpack), the size of the battery 22 may be of reduced importance. Typically, the selection of a size and type of battery 22 weighs the desired power with the desired comfort for the user.

In other embodiments of the invention, the battery 22 is a flexible lithium ion battery, such as a thin film rechargeable lithium battery (not illustrated). In these embodiments, the battery 22 is configured to flex and deflect with the light display assembly 12 so as to conform to the wearer's body.

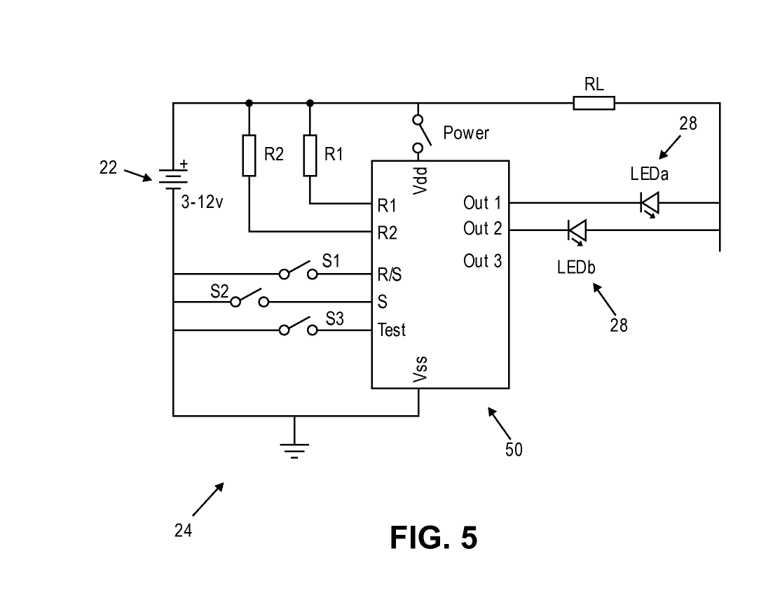

The circuit board 24 controls the lighting of the light source 26. The circuit board 24 receives or otherwise acquires an indication to begin the lighting sequence. The circuit board 24 then controls various switches, brightness controls, and/or pulse-width modulators so as to cause the light source 26 to produce light according to the desired lighting sequence. An exemplary circuit board 24 is illustrated in FIG. 5. An integrated circuit controls the LEDa and LEDb such that the two LEDs 28 produce light according to the desired lighting sequence. The integrated circuit may selectively utilize either resister R1 and R2 so as to adjust the brightness or color produced by the light source 26. It should be appreciated that FIG. 5 is only an exemplary simplified circuit board 24 for clarity.

The circuit board 24 instructs the light source 26 to produce light according to a certain sequence. The circuit board 24 instructs the light source 26 to begin producing the light in response to a certain trigger. The trigger may come from the motion activation switch 42 (discussed below), a magnetic activation switch (not illustrated but discussed below), a light sensor, a manual activation switch, a proximity detector, etc. The trigger may also come from a pre-determined time interval as tracked by the circuit board 24.

In embodiments of the invention, the sequence is fixed. As such, the sequence displays lights in the same manner and sequence in response to each trigger. In these embodiments, the lighting sequence may be hard-wired into the circuit board 24. The sequence may also be selected from a set of fixed sequences. For example, the circuit board 24 may be programmed with certain number of fixed sequences (two, three, four, five, ten, twenty, etc.). Upon receiving a trigger, the circuit board 24 selects one fixed sequence from the set to display. The selected sequence may be the next sequentially, associated with the type of trigger, chosen randomly, etc. In other embodiments, the sequence is variable. For example, the circuit board 24 may generate or alter the sequence based upon numerous factors (such as the type of trigger, the length of the trigger, the number of previous triggers, etc.) In still other embodiments, the sequence is random.

In some embodiments the sequence is customizable, such that a user can select and change the certain sequence. The circuit board 24 of these embodiments therefore includes an input. The input allows the circuit board 24 to receive instructions as to a desired new sequence. The input could be wired (e.g., a mini-USB port, a micro-USB port, or the like), wireless (e.g., a BLUETOOTH receiver or the like), or direct input (such as a light sensor that interprets detected light, which may be produced by a phone or computer of the user to communicate the desired sequence).

In some embodiments of the invention, the circuit board 24 is flexible so as to flex in association with a flexing of the textile. For example, the circuit board 24 may be formed in part of Mylar flexible electronics or other nano-substrates. In these embodiments, the circuit board 24 will bend and deflect substantially in line with the water-tight enclosure 20 and the textile. This reduces damage to the circuit board 24 and the water-tight enclosure 20 and reduces the noticeability of the components.

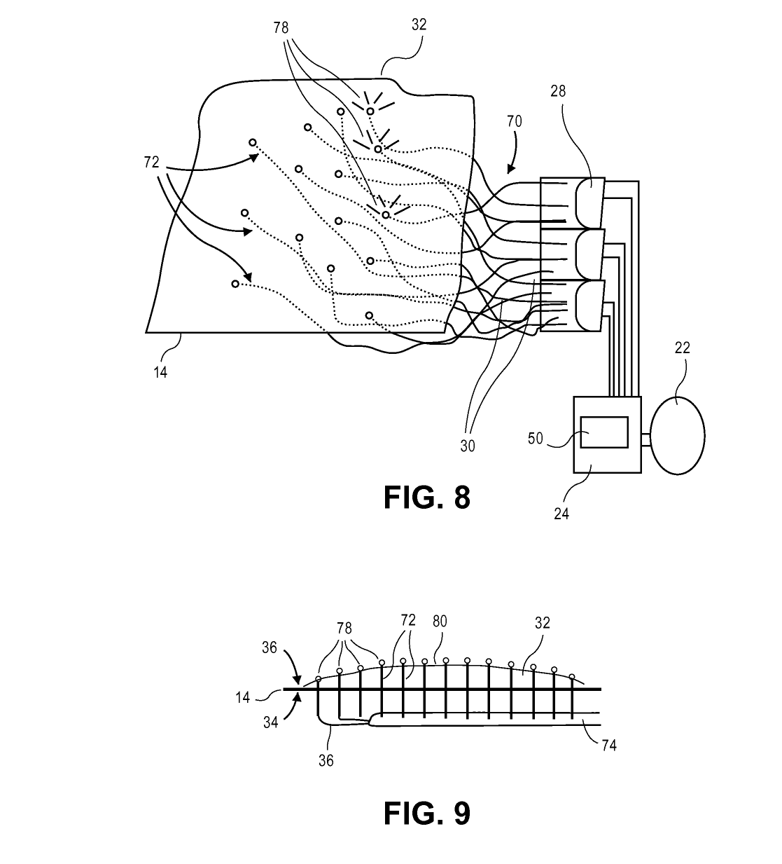

In embodiments of the invention, the light source 26 is a light-emitting diode 28, as illustrated in FIG. 4 and FIG. 8. The light-emitting diode 28 (LED) is a two-lead semiconductor light source that emits light when activated. When a suitable voltage is applied to the leads from the battery 22 via the circuit board 24, electrons are able to recombine with electron holes within the LED 28, releasing energy in the form of photons. This effect is called electroluminescence, and the color of the light (corresponding to the energy of the photon) is determined by the energy band gap of the semiconductor. An LED 28 is often small in area (e.g., less than 1 mm²) and integrated optical components may be used to shape its radiation sequence. In some embodiments, the LEDs 28 are uni-directional. In other embodiments, the LEDs 28 are omni-directional. A housing may funnel the light from the LEDs 28. In other embodiments, each LED 28 is directly linked to an individual component of the light-emitting segment 18. Additionally, the LEDs 28 may be soldered (or otherwise secured) directly at the edge of the circuit board 24 so as to reduce wiring.

In embodiments of the invention, the light generated is in a range of 300 nm to 500 nm to duplicate natural sunlight. In other embodiments of the invention, the light generated is in a range of 380 nm to 800 nm to span the visible spectrum. In still other embodiments, the light generated is in the ultraviolet and/or infrared spectrums. Light in the ultraviolet and/or infrared spectrums may be useful for the covert identification and authentication discussed above.

In embodiments of the invention, the light-generating segment 16 include a plurality of LEDs 28. The plurality of LEDs 28 may be of multiple colors or of the same color. Multiple LEDs 28 of multiple colors allows for numerous different colors to be emitted, including a blending of primary colored LEDs 28 to create secondary colors. Multiple LEDs 28 of the same color allow for timing differentiation. The colors can move across the design decal 32 based upon the timing of the LEDs 28 producing light and the corresponding locations of the optical fibers 30, as illustrated in FIG. 8.

In embodiments of the invention, the light-generating segment 16 includes the motion activation switch 42 configured to provide an indication of motion to the light-generating segment 16. In embodiments of the invention, the motion activation switch 42 comprises an enclosed spring 52 with a core 54, as illustrated in FIG. 4. A certain amount of motion (such as running or jumping by the wearer) trips the enclosed spring 52. The certain amount of motion also prevents excessive battery 22 drain by reducing the amount of incidental lighting sequences. The motion activation switch 42 provides (either passively or actively) an indication of the motion to the circuit board 24. In embodiments of the invention, the motion activation switch 42 located directly on the circuit board 24, so as to more accurately detect motion. The motion activation switch 42 is therefore also surrounded directly by the water-tight enclosure 20, as discussed below.

In embodiments of the invention, the light-generating segment 16 begins a lighting sequence based upon receiving the indication of motion. The indication of motion indicates that the wearer is actively moving and as such the lighting sequence may be desirable. For example, if the wearer is a child, the lighting sequence may encourage the child to be active because activity begins the lighting sequence. Similarly, if the wearer is a utility worker, the lighting sequence is desirable for safety reasons during the performance of work. In this way, the utility worker need not remember to turn on the light display assembly 12 because the light display assembly 12 emits the light automatically during the worker's physical activity.

In embodiments of the invention, the light-generating segment 16 further includes a magnetic activation switch (not illustrated). The magnetic activation switch is configured to provide an indication of the presence of a magnetic field to the circuit board 24. The light-generating segment 16 will not produce light so long as the magnetic activation switch is providing said indication. The magnetic activation switch is used to deactivate the light display assembly 12. The magnetic activation switch can be manipulated by the user to essentially turn off the light display assembly 12 without physically manipulating the light display assembly 12. For example, during shipment of the lighted textile system 10 and/or light display assembly 12, the shipper can place a magnet in a pocket 40 of the lighted textile assembly, in the box with the lighted textile assembly, in the shipping container with the lighted textile assembly, etc. In this way, the battery 22 of the lighted display assembly is not being depleted during transportation and shipping. This allows the consumer to receive the lighted textile system 10 with the maximum possible battery 22 life remaining. The retailer or consumer could then remove the magnet to allow the light display assembly 12 to begin the lighting sequences. In embodiments of the invention, the magnetic activation switch and the motion activation switch 42 are both utilized on the light display assembly 12.

In some embodiments, the light display assembly 12 includes a pressure activation switch 56, as illustrated in FIG. 1B and FIG. 4. The pressure activation switch 56 allows the user to turn the light display assembly 12 on and off by applying a manual pressure to the switch. The pressure activation switch 56 is separated from the circuit board 24 so as to allow the wearer to compress the switch without causing damage to any components. The pressure activation switch 56 may also include an external indication, typically on the rough side 34 of the textile, to show the wearer where to press to provide the input. It should be appreciated that the flexible water-tight enclosure allows the wearer to depress the pressure activation switch 56 without causing damage to the pressure activation switch 56 or any other components. In other embodiments, no pressure activation switch 56 is utilized and control of the light display assembly 12 is accomplished via the motion activation switch 42 and/or the magnetic activation switch.

At least a portion of the light display assembly 12 is secured within the water-tight enclosure 20, as best illustrated in FIGS. 6 and 7. The water-tight enclosure 20 is secured directly to the rough side 34 of the textile article 14. By securing the water-tight enclosure 20 directly to the textile article 14, potentially damaging movement and jostling of the light display assembly 12 is reduced. The water-tight enclosure 20 also reduces bulging and visibility of components (other than the design decal 32 and the optical fibers 30) so as to improve aesthetics.

In embodiments of the invention, the water-tight enclosure 20 encases the light-generating segment 16 and at least a portion of the light-emitting segment 18. In other embodiments of the invention, the water-tight enclosure 20 surrounds the entirety of the light display assembly 12. The water-tight enclosure 20 allows the light display assembly 12 to withstand numerous washings of the lighted textile system 10. During the washings, the user need not (and in embodiments of the invention, cannot) remove the light display assembly 12 or the battery 22 associated therewith.

In embodiments of the invention, the water-tight enclosure 20 comprises a backing 58 and a mold cover 60. The backing 58 is applied directly to the textile, as best illustrated in FIG. 6. The various components of the light display assembly 12 are then placed on the backing 58. The mold cover 60 is then emplaced over the components and secured to the backing 58 so as to provide a permanent, water tight surrounding for the various components. In embodiments of the invention, the water-tight enclosure 20 is formed at least in part of silicon or a silicon-based material.

The backing 58 is a first layer that is applied directly to the textile so as to reduce the markings that can appear on the textile following repeated washings. For example, on a jean pocket 40 such as illustrated in FIG. 2, it is common for washings to create a white outline around the components. The white outline is caused during the washing process when the impression of the battery 22 and other components rub against the denim fabric and due to the fading of the indigo dye within the fabric. However, the backing 58 prevents this by spreading outline out away from the components, such that no component is near the edge of the backing 58. The backing 58 is therefore disposed between the light-generating segment 16 and the textile article 14.

In embodiments of the invention, such as illustrated in FIGS. 1A and 1B, the backing 58 covers all or substantially all of the rough side 34 of the textile for a certain portion of the textile article 14 (such as the jean pocket 40). This prevents the markings by placing the edges of the backing 58 proximate to natural edges in the textile article 14. In this way any markings that do develop along the edges of the backing 58 will not be noticeable because they will be proximate stitching or other natural breaks in the textile article 14. In other embodiments, the backing 58 is of a shape that would be aesthetically pleasing, such that any markings that do develop would be aesthetically pleasing. The shape of the backing 58 may therefore be related to the shape of the display decal or the arrangement of the ends of the optical fibers 30.

In embodiments of the invention, a waterproofing compound is applied to the components of the light-generating segment 16 so as to prevent water damage. The waterproofing compound may be applied during installation of the light display assembly 12 onto the textile article 14 or previously (such as during the manufacture of the light display assembly 12). Common waterproofing compounds include Techspray Fine-L Kote Silicon Conformal Coating and Performix Plasti Dip. The waterproofing compound provides secondary protection to the various components in the event that a small hole or tear develops in the water-tight enclosure 20 due to wear or damage.

The mold cover 60 is a second layer of the water-tight enclosure 20 that is configured to encompass the light-generating segment 16. In some embodiments, the mold cover 60 may also encompass at least a portion of the light-emitting segment 18. As illustrated in FIG. 6, the mold cover 60 may present a complementary lower side 62 and a tapered upper side 64. The complementary lower side 62 is placed against the components. The complementary lower side 62 may present a complementary shape to the components or it may flex and conform to the shape of the components. The tapered upper side 64 presents a tapered edge 66 and a substantially flat or substantially arcuate center 68, as illustrated in FIG. 7.

In embodiments of the invention, the center 68 of the mold cover 60 is substantially the same size as the light-generating segment 16 and the tapered edge 66 extends outward therefrom. As discussed above, in some embodiments the backing 58 covers the entire pocket 40 or other section of the textile article 14. Therefore, the backing 58 may be at least 50% larger in surface area than the mold cover 60, at least twice as large as the mold cover 60, at least three times as large as the mold cover 60, etc.

The light-emitting segment 18 is configured to receive light from the light-generating segment 16 and emit the light so as to be viewable from the finished side 36 of the textile. The light-emitting segment 18 receives the light produced by the light-generating segment 16 and directs the light such that it will be emitted in an aesthetically pleasing and/or highly visible manner, as illustrated in FIG. 8. The light-emitting segment 18 typically comprises a plurality of optical fibers 30 and a design decal 32. The optical fibers 30 are secured at a proximal end 70 to the light-generating segment 16 and secured at a distal end 72 to the design decal 32.

In embodiments of the invention, the light-emitting segment 18 comprises at least one fiber optic cable. The fiber optic cable transmits the photons that were emitted by the light-generating segment 16 to the observer. The fiber optic cable is electrically isolative and resistant to water damage because it is formed of polymethyl methacrylate (PMMA), Styrene plastic, or other glass instead of metal. The fiber optic cable comprises at least one optical fiber 30. In some embodiments, the fiber optic cable comprises a single optical fiber 30 or a plurality of optical fibers 30 that each carry light.

In some embodiments, a plurality of fiber optic cables may be used. Multiple fiber optic cables provide redundancy, additional colors, and carry additional light. In embodiments of the invention, each of the plurality of fiber optic cables is connected to the light source 26. In other embodiments, the plurality of fiber optic cables is attached to multiple light sources 26. The plurality of optical fibers 30 may be contained within a protective sheath 74 that protects the optical fibers 30 from damage and abrasion from the environment. The protective sheath 74 is formed of plastic or another polymer. Crimping of the fiber optic cable is a concern. Crimping of a fiber optic cable can produce serious and irreparable damage to the fiber optic fibers. To prevent crimping, in embodiments of the invention, the fiber optic cable is provided with slack such that it can bend naturally, and/or covered at least in part with the water-tight enclosure 20 and/or design decal 32 to protect the optical fibers 30.

A plurality of optical fibers 30 may be secured to each light source 26 such that the light produced by that light source 26 will be displayed in a corresponding plurality of locations on the design decal 32. Similarly, a plurality of optical fibers 30 may be disposed in a single location in the design decal 32. The plurality of optical fibers 30 allows different color light sources 26 to be blended to form new colors or allows each location to produce different colors according to the lighting sequence.

In embodiments of the invention, a heat shrink 74 is applied around the optical fibers 30 to secure the optical fibers 30 to the light source 26. The heat shrink 74 holds the optical fibers 30 securely to the light source 26 and may include an additional internal reflective layer such as aluminum foil therein. As such that no or a minimal amount of light is lost. The heat shrink 74 also prevents the optical fibers 30 from pulling away from the light source 26, so as to reduce the likelihood of damage, as illustrated in FIG. 4.

In embodiments of the invention, the distal end 72 of the optical fibers 30 present a mushroom end 78 so as to array the light, as illustrated in FIG. 9. This allows for easy viewing of the light from multiple angles. Typically, the light emitted from the optical fibers 30 is done so in a substantially straight forward direction (i.e. in line with the angle at which the light exits the optical fiber 30). The optical fibers 30 are also evenly cut to control the same level of brightness emitted for each optical fiber 30. This provides consistency in appearance as viewed from the finished side 36. In embodiments of the invention, the optical fibers 30 are installed with slack between the light source 26 and the design decal 32. The slack prevents breakage of the optical fibers 30 during flexing of the textile during wear.

In embodiments of the invention, the design decal 32 is configured to be secured to the finished side 36 of the textile, as illustrated in FIG. 9. The design decal 32 can take any of numerous shapes and styles. For example, the design decal 32 can illustrated a movie character, a geometric shape, a logo of the manufacturer of the textile article 14, a logo of another organization associated with the wearer, a custom design created by the consumer, etc. For example, the logo may be indicative of a company for which the wearer works and the textile article 14 is part of a uniform worn by employees. As another example, the design decal 32 may be of a popular children's character. The lighted display assembly adding a lighting sequence to the children's character would therefore be aesthetically pleasing to the child.

In some embodiments of the invention, the design decal 32 presents a plurality of openings (not illustrated). The design decal 32 is therefore configured to receive the optical fibers 30. The distal end 72 of said optical fibers 30 are disposed in each said plurality of openings. The distal end 72 of each optical fiber 30 may be secured within the opening by the mushroom end 78 of the distal end 72, by an adhesive, or the like.

In embodiments of the invention, the design decal 32 is a puff print 80, as illustrated in FIG. 9. Puff print 80 is a patch produced by a printing process in which a screen-printed designs puff up when applied with a heat press. The puff print 80 therefore rises above the textile onto which they are transferred. The distal end 72 of the optical fibers 30 may be disposed into or through the puff print 80 to provide an area lighting or a precision lighting, respectively.

In other embodiments of the invention, no design decal 32 is utilized. In these embodiments, the optical fibers 30 traverse the textile and are secured thereto by an adhesive. The optical fibers 30 then produce light as described above, but are difficult to see when not displaying light. These embodiments may be especially useful in safety equipment in which the aesthetic qualities of the design decal 32 are less important.

Although the invention has been described with reference to the exemplary embodiments illustrated in the attached drawings, it is noted that equivalents may be employed and substitutions made herein without departing from the scope of the invention as recited in the claims.

Having thus described various embodiments of the invention, what is claimed as new and desired to be protected by Letters Patent includes the following:

1. A light display assembly configured to be affixed to a textile, the light display assembly comprising:
a light-generating segment configured to be disposed adjacent to a rough side of the textile;
a light-emitting segment configured to receive light from the light-generating segment and emit the light so as to be viewable from a finished side of the textile; and
a water-tight enclosure that encases the light-generating segment and at least a portion of the light-emitting segment.

2. The light display assembly of claim 1, further comprising:
a motion activation switch configured to provide an indication of motion to the light-generating segment,
wherein the light-generating segment begins a lighting sequence based upon receiving said indication of motion.

3. The light display assembly of claim 1, further comprising:
a magnetic activation switch configured to provide an indication of the presence of a magnetic field,
wherein the light-generating segment will not produce light when the magnetic activation switch is providing said indication.

4. The light display assembly of claim 1,
wherein the water-tight enclosure is formed at least in part of silicone,
wherein the water-tight enclosure is configured to withstand a washing of the textile without damaging the light-generating assembly.

5. The light display assembly of claim 1, wherein the water-tight enclosure includes:
a first layer configured to be disposed between the light-generating segment and the textile; and
a second layer configured to encompass the light-generating segment.

6. The light display assembly of claim 5, wherein the light display assembly is secured to the textile by:
applying said first layer directly to the textile,
placing the light-generating segment onto the first layer of the water-tight enclosure, and
covering the first layer and the light-generating segment with the second layer of the water-tight enclosure,
wherein applying the first layer to the textile conforms the light-generating segment to the textile such that the light-generating segment cannot be readily observed from said finished side of the textile.

7. The light display assembly of claim 1, wherein the light-generating segment includes:
a battery;
a circuit board; and
a light-emitting diode.

8. The light display assembly of claim 7, wherein said battery is a button cell that is irreplacably enclosed within the water-tight enclosure.

9. The light display assembly of claim 7, wherein said circuit board is flexible so as to flex in association with a flexing of the textile.

10. The light display assembly of claim 7, wherein said circuit board instructs said light-emitting diode to produce light according to a certain pattern.

11. The light display assembly of claim 10, wherein said certain pattern is customizable, such that a user can select and change the certain pattern.

12. The light display assembly of claim 1, wherein the light-emitting assembly includes:
a plurality of optical fibers,
said optical fibers being secured at a proximal end to the light-generating assembly.

13. The light display assembly of claim 12, wherein a distal end of said optical fibers is mushroomed so as to array the light.

14. The light display assembly of claim 12, wherein the light-emitting assembly further includes:
a design decal configured to be secured to the finished side of the textile,
wherein the design decal presents a plurality of openings,
wherein a distal end of said optical fibers are disposed in each said plurality of openings.

15. A lighted textile system comprising:
a textile article presenting a finished side that is viewable by an observer and a rough side that is obscured from the observer;
a light-generating segment secured to the rough side of the textile article;
a light-emitting segment configured to receive light from the light-generating segment and emit the light so as to be viewable from the finished side of the textile article; and
a water-tight enclosure that encases the light-generating segment and at least a portion of the light-emitting segment such that the lighted textile system can be washed.

16. The lighted textile system of claim 15, wherein said light-emitting segment includes:
a plurality of optical fibers; and
a design decal disposed on the finished side of the textile article,
wherein at least a portion of each optical fiber traverses the textile article and the design decal,
wherein the light emitted from the optical fibers is viewable directly from the finished side.

17. The lighted textile system of claim 15, wherein said light-generating segment includes:
a non-replaceable battery;
a light source secured to the light-emitting segment; and
a circuit board configured to instruct the light source according to a certain pattern.

18. A method of displaying a light pattern on a textile article, the method comprising the following steps:
programming a circuit board with a set of instructions indicative of the desired light pattern;
securing the circuit board, a light source, and a battery to a rough side of the textile article;
securing a distal end of a plurality of optical fibers to the light source such that a proximal end of said plurality of optical fibers directs the light toward a finished side of the textile article; and
encasing the circuit board, the light source, and the battery in a water-tight enclosure so as to allow the textile article to be safely washed without removing the circuit board, the light source, and the battery.

19. The method of claim 18,
wherein said securing to the rough side of the textile article is performed by applying a silicone-based adhesive to the rough side and placing the circuit board, the light source, and the battery thereon,
wherein said silicone-based adhesive is water resistant and able to withstand repeated washing without being readily visible from the finished side,
wherein said encasing in a water-tight enclosure is performed by applying the silicone-based adhesive atop the circuit board, the light source, and the battery.

20. The method of claim 18, further comprising the following step:
securing a design decal to the finished side of the passing the distal end of the fiber optic cable through the textile
